(19) United States
(12) Patent Application Publication
(10) Pub. No.: US 2015/0179368 A1
(43) Pub. Date: Jun. 25, 2015

(54) SAFETY GUARD ASSEMBLY

(71) Applicant: Smiths Heimann GmbH, Wiesbaden (DE)

(72) Inventors: Kristofer Roe, Port Deposit, MD (US); Rainer Henkel, Schweppenhausen (DE)

(73) Assignee: Smith Heimann GmbH, Wiesbaden (DE)

(21) Appl. No.: 14/407,373

(22) PCT Filed: Jun. 11, 2013
(86) PCT No.: PCT/US2013/045224

§ 371 Date: Dec. 11, 2014

Related U.S. Application Data
(60) Provisional application No. 61/658,062, filed on Jun. 11, 2012.

(51) Int. Cl. H01H 13/14

(52) U.S. Cl. CPC H01H 13/14

(57) ABSTRACT

Provided herein are devices, assemblies, and methods of use thereof to prevent inadvertent actuation of an element while allowing intentional actuation by a user.

This application claims priority to U.S. Provisional Application No. 61/658,062, filed Jun. 11, 2012, which is herein incorporated by referenced in its entirety.

### FIELD

Provided herein are devices, systems, assemblies, and methods of use thereof to prevent inadvertent actuation of an element while allowing intentional actuation by a user.

### BACKGROUND

Many systems and devices have emergency stops (E-stops), buttons or switches that immediately cut off the power to the system or device or initiate an emergency shut-down procedure. To be clearly visible and easily accessible in an emergency, E-Stops are typically installed at a prominent location on the system or device (e.g. housing, keyboard etc). The downside of such prominent placement is that E-stops can be inadvertently triggered by contact with an object (e.g., cell phone, clipboard, tray, etc.) or inadvertent contact by a user. Accidental shut down of a system or device results in disruption of operational flow, lost data, and/or lost productivity.

### SUMMARY

In some embodiments, provided herein is a system comprising: an actuatable element configured to adopt a raised position and a depressed position, and a guard element surrounding the actuatable element, wherein the guard element has a top edge and the actuatable element has a top surface, wherein the top surface of the actuatable element is higher than the top edge of the guard element when the actuatable element is in the raised position, wherein the top edge of the guard element is higher than the top surface of the actuatable element when the actuatable element is in the depressed position, and wherein the guard element encloses all or a portion of the periphery of the actuatable element but does not obstruct the top surface of the actuatable element. In some embodiments, the guard element comprises a lower portion that completely encloses the periphery of the actuatable element, and an upper portion that partially encloses the periphery of the actuatable element. In some embodiments, the lower portion of the guard element comprises a ring structure, and wherein the ring structure encircles the bottom of the actuatable element. In some embodiments, the upper portion comprises one or more arc segments and one or more gaps, wherein the arc segments of the upper portion partially encircle the actuatable element. In some embodiments, the upper portion comprises two arc segments and two gaps. In some embodiments, each of the two arc segments are of equal length and the two gaps are of equal length. In some embodiments, each arc segment has a central angle of 70-110°. In some embodiments, each arc segment has a central angle of about 90°. In some embodiments, the top surface of the actuatable element is 1-5 mm higher than the top edge of the guard element when the actuatable element is in the raised position. In some embodiments, the top surface of the actuatable element is about 3.5 mm higher than the top edge of the guard element when the actuatable element is in the raised position. In some embodiments, the actuatable element comprises a button. In some embodiments, the button comprises a top surface, stalk, and base element. In some embodiments, the base element is attached to a device or apparatus. In some embodiments, the button is an emergency stop button for the device or apparatus. In some embodiments, the stalk is configured to retract into and extend from the base element. In some embodiments, application of a force from above the top surface results in the stalk retracting into the base element and the actuatable element moving from the raised position to the depressed position. In some embodiments, the guard element limits access for the application of force to the actuatable element.

In some embodiments, provided herein is a system comprising: an actuatable element configured to adopt a raised position and a depressed position, and a guard element surrounding the actuatable element, wherein the guard element has a top edge and the actuatable element has a top surface, wherein the top edge of the guard element is higher than the top surface of the actuatable element when the actuatable element is in the depressed position, and wherein the guard element encloses all or a portion of the periphery of the actuatable element but does not obstruct the top surface of the actuatable element. In some embodiments, the top surface of the actuatable element is lower (e.g., 1 mm . . . 2 mm . . . 3 mm . . . 4 mm . . . 5 mm . . . 10 mm, etc.) than the top edge of the guard element when the actuatable element is in the raised position. In some embodiments, the top surface of the actuatable element the same height as the top edge of the guard element when the actuatable element is in the raised position. In some embodiments, the top surface of the actuatable element is higher (e.g., 1 mm . . . 2 mm . . . 3 mm . . . 4 mm . . . 5 mm . . . 10 mm, etc.) than the top edge of the guard element when the actuatable element is in the raised position.

In some embodiments, partial depression of an actuatable element is insufficient to cause and/or initiate a result from the actuatable element. In some embodiments, partial actuation of an actuatable element is insufficient to cause and/or initiate the same result as complete actuation to the fully actuated (e.g., depressed) position. In some embodiments, a guard element prevents complete actuation (e.g., depression) by rigid object larger than the opening of the guard element, thereby preventing the result of full actuation (e.g., depression) by such objects.

In some embodiments, provided herein is a method of preventing unintentional actuation of an actuatable element, while allowing intentional actuation of the actuatable element comprising providing a guard element around the actuatable element, wherein the actuatable element has a raised and a lowered position, wherein the guard element limits access to the actuatable element for the periphery of the actuatable element, wherein the guard element has a top opening that allows access from above the actuatable element to objects smaller that the top opening of the guard element, wherein the guard element prevents a rigid object with a cross-section larger than the top opening of the guard element from actuation the actuatable element from the raised position to the depressed position, and wherein the guard element allows a sufficiently flexible or malleable object with a cross-section larger than the top opening of the guard element to actuate the actuatable element from the raised position to the depressed position. In some embodiments, the actuatable element is a button. In some embodiments, the sufficiently flexible or malleable object is the hand, palm, of fingers of a user.

### DESCRIPTION OF THE FIGURES

FIGS. 1-3 show separate views of exemplary systems provided by embodiments described herein.

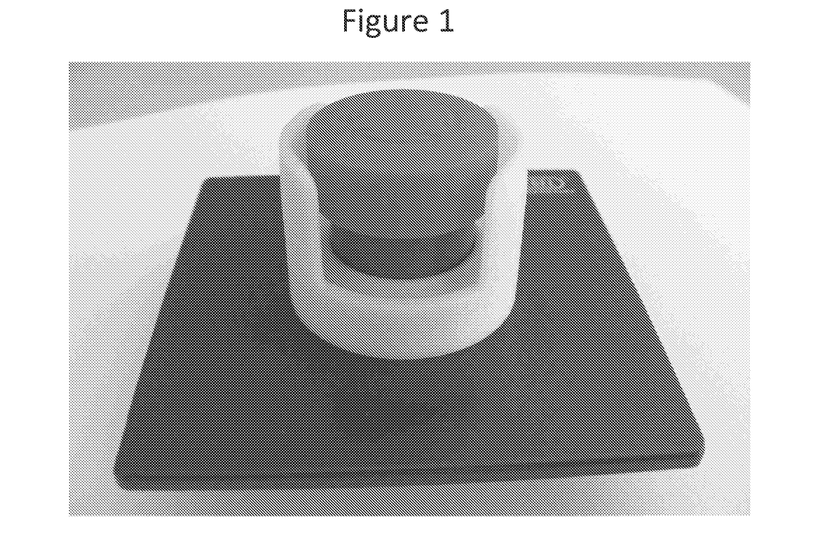

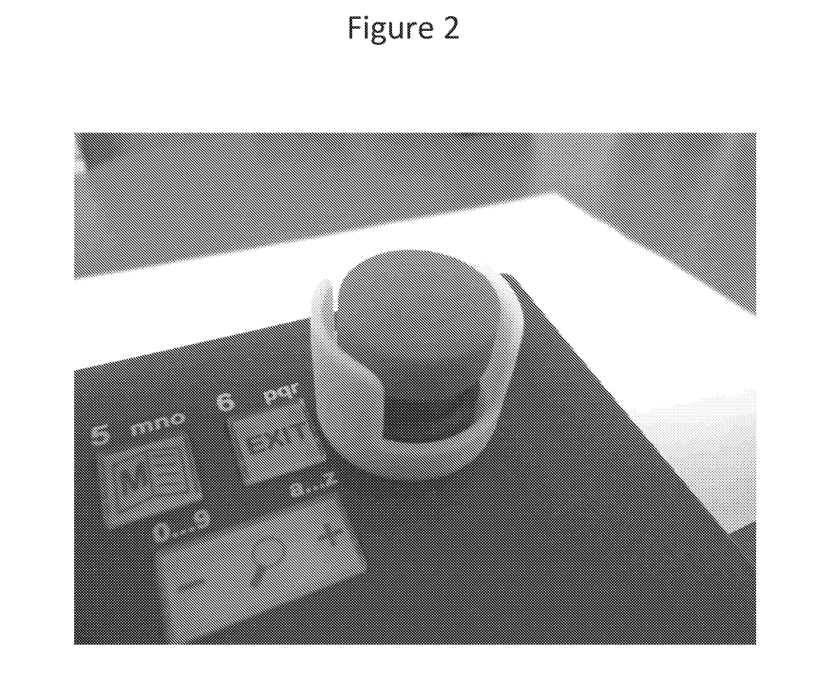

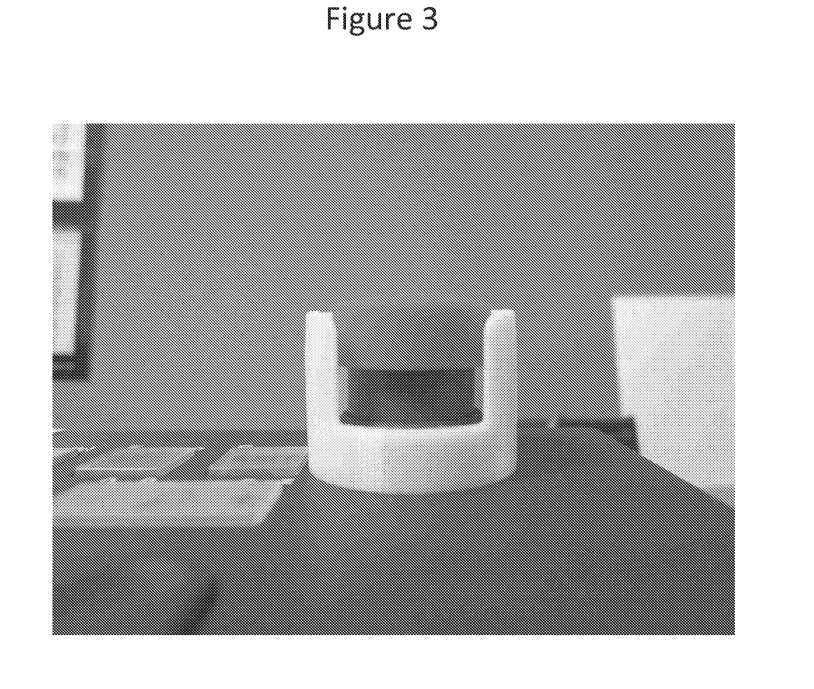

### DEFINITIONS

As used herein, the term “actuatable” refers to any object or element that can be put into mechanical action or motion. An “actuatable element” is at capable of being moved from at least a first position to at least a second position.

### DETAILED DESCRIPTION OF THE INVENTION

The following description provides exemplary embodiments of the present invention. The present invention is not limited to these exemplary embodiments.

In some embodiments, provided herein is an actuatable element (e.g., button, switch, etc.) partially shrouded by a guard element (e.g., to prevent inadvertent actuation while allowing intentional actuation (e.g., by a user)). In some embodiments, a guard element allows the actuatable element to be contacted by any object that is brought into its immediate proximity; however, only an object that can fit within the opening of the guard element (e.g., fingers) or an object that is malleable enough to conform with the opening of the guard element (e.g., the palm of a hand) is capable of fully actuating the actuatable element to elicit the desired response (e.g., emergency stop).

In some embodiments, an actuatable element is a button, switch, lever, toggle, or other element capable of, or configured to, transmit, initiate, and/or produce a result through its movement. In some embodiments, an actuatable element is configured to be actuated by a user. In some embodiments, an actuatable element is configured to be actuated by the hand or fingers of a user. In some embodiments, an actuatable element is configured to be actuated by an object, device or other element. In some embodiments, an actuatable element is configured to adopt two positions (e.g., actuated/unactuated, first/second, off/on, active/inactive, operational/shut-off, up/down, raised/depressed, etc.). In some embodiments, an actuatable element is configured to adopt two extreme positions and one or more intermediate positions (e.g., partially depressed positions). In some embodiments, an actuatable element is configured to adopt a large (e.g., approaching infinity) number of intermediate positions. In some embodiments, a force is applied (e.g., by a user) to an actuatable element to move it from a first position (e.g., raised position) to a second position (e.g., depressed position). In some embodiments, a force is applied (e.g., by a user) in the opposite direction (e.g., lifting) to return the actuatable element from the second position (e.g., depressed position) to the first position (e.g., raised position). In some embodiments, an actuatable element automatically returns from a second position (e.g., depressed position) to a first position (e.g., raised position) upon removing the applied force (e.g., removing the hand of the user from the actuatable element). In some embodiments, an actuatable element is spring-loaded to maintain the actuatable element in a defined position (e.g., raised position) in the absence of an external force (e.g., applied by the user). In some embodiments, an actuatable element is depressed through the application of a force (e.g., by a user) to move the actuatable element from a first position (e.g., raised position) to a second position (e.g., depressed position). In some embodiments, the actuatable element is again depressed to return the actuatable element from the second position (e.g., depressed position) to the first position (e.g., raised position).

In some embodiments, an actuatable element is a button. In some embodiments, a button comprises a top surface supported by a stalk. In some embodiments, the stalk is configured to fit within a base element. Upon application of sufficient pressure to the top surface (e.g. 10 N . . . 20 N . . . 50 N . . . 100 N . . . 200 N . . . 500 N, etc.), the stalk retracts into the base element. In some embodiments, when the stalk is retracted into the base element, the button is in the depressed position. In some embodiments, when the stalk is extended from the base element, the button is in the raised position. In some embodiments, application of a force (e.g. 10 N . . . 20 N . . . 50 N . . . 100 N . . . 200 N . . . 500 N, etc.) is used to move the button from the raised position to the depressed position. In some embodiments, application of a force (e.g. 10 N . . . 20 N . . . 50 N . . . 100 N . . . 200 N . . . 500 N, etc.) is required to maintain a button in the depressed position. In some embodiments, a button comprises a mechanism (e.g., latch) to hold the button in the depressed position following release of applied pressure. In some embodiments, a button comprises a mechanism (e.g., spring) to automatically return the button to the raised position upon release of applied pressure. In some embodiments, a lift force is required to return the button from the depressed position to the raised position. In some embodiments, application of a force to the top surface of a button in the depressed position results in return of the button to the raised position.

In some embodiments, a button is an emergency-stop button (a.k.a. E-stop). In some embodiments, an E-stop is attached to a device, system, and/or apparatus (e.g., security scanner). In some embodiments, moving an E-stop into the depressed position results in cutting off of power to the attached device, system, and/or apparatus. In some embodiments, moving an E-stop into the depressed position results in powering down of the attached device, system, and/or apparatus.

In some embodiments, a guard element is provided to prevent the inadvertent depressing of an actuatable element, button, and/or E-stop.

In some embodiments, a guard element is adjacent to and/or surrounds (e.g., completely or partially) an actuatable element. In some embodiments, a guard element shrouds all sides of an actuatable element. In some embodiments, In some embodiments, a guard element shrouds more than about 20% of the periphery of actuatable element (e.g., about 25%, about 30%, about 40%, about 50%, about 75%, about 90%, about 99%, and portions therein). In some embodiments, a guard element is taller than the highest position an actuatable element is capable of adopting (e.g., raised position). In some embodiments, a guard element is taller than the depressed position of an actuatable element. In some embodiments, a guard element is taller than the depressed position, but shorter than the raised position of an actuatable element. In some embodiments, the top of the guard element extends at least 20% of the distance from the top of the actuatable element when in the depressed position to the top of the actuatable element when in the raised position (e.g., 25%, 30%, 40%, 50%, 75%, 90%, 99%, and positions therein). In some embodiments, the top of the guard element is at least 1 mm below the top of the actuatable element when in the raised position (e.g., 1 mm . . . 2 mm . . . 3 mm . . . 4 mm . . . 5 mm . . . 6 mm . . . 7 mm . . . 8 mm . . . 9 mm . . . 1 cm . . . 2 cm . . . 5 cm . . . 10 cm, etc.). In some embodiments, the top of the guard element is 3.5 mm below the top of the actuatable element when in the raised position.

In some embodiments, a guard element surrounds an actuatable element while occupying a minimal footprint (e.g., in the x-y plane). In some embodiments, a guard element is less than 1 cm in width (e.g. 9 mm, 8 mm, 7 mm, 6 mm, 5 mm, 4 mm, 3 mm, 2 mm, 1 mm, etc.). In some embodiments, the material forming a guard element is less than 1 cm in width (e.g. 9 mm, 8 mm, 7 mm, 6 mm, 5 mm, 4 mm, 3 mm, 2 mm, 1 mm, etc.).

In some embodiments, a guard element prevents a rigid object that is larger than the opening in the guard element from actuating (e.g., fully actuating) the actuatable element. In some embodiments, a flexible, soft, and/or malleable object (e.g., hand, palm, fingers) that is larger than the opening of a guard element is capable of fully depressing an actuatable element. In some embodiments, sufficient force (e.g., a firm strike by a user (e.g., user of average strength)) is required by a flexible, soft, and/or malleable object (e.g., hand, palm, fingers) to cause the object to conform to conform to the opening of the guard element and to fully depress the actuatable element. In some embodiments, when a rigid object that is larger than the opening of the guard element strikes (or attempts to strike) the actuatable element, the guard element prevents the object from depressing (e.g., fully depressing) the actuatable element. Because the rigid object cannot conform to the opening of the guard element, it cannot depress the actuatable element from a first position to a second position. In some embodiments, a guard element prevents a rigid object larger than the opening of the guard element from contacting the actuatable element. In some embodiments, a flexible object (e.g., hand, palm, fingers, etc.) capable of conforming to the opening of a guard element is able to contact the actuatable element and actuate it (e.g., depress it). In some embodiments, a flexible object (e.g., hand, palm, fingers, etc.) is capable of conforming to the opening of the guard element, contacting the actuatable element, and fully depressing it into the depressed position.

In some embodiments, a guard element comprises a lower portion and an upper portion. In some embodiments, a guard element comprises more than one upper portions. In some embodiments, a lower portion is a ring structure. In some embodiments, a ring structure is configured to surround the periphery of an actuatable element. In some embodiments, a ring structure is configured to surround the base of an actuatable element. In some embodiments, the lower portion of the guard element surrounds the periphery of the base of an actuatable element. In some embodiments, one or more (e.g., 1, 2, 3, 4, 5, 6, or more) upper portions extend upward from a lower portion. In some embodiments, one or more (e.g., 1, 2, 3, 4, 5, 6, or more) upper portions extend upward from a ring structure. In some embodiments, an upper portion is a ring structure or a partial ring structure (e.g., arc segment). In some embodiments, one or more partial ring structures (e.g., arc segments) surround a portion of the periphery of an actuatable element. In some embodiments, one or more partial ring structures (e.g., arc segments) combine to surround greater than 20% of the periphery of an actuatable element (e.g., 25%, 30%, 40%, 50%, 75%, 90%, 100%, or any portions therein). In some embodiments, gaps exist between the ends of one or more partial ring structures (e.g., arc segments). In some embodiments, one partial ring structure (e.g., arc segment) and one gap extend upward from a lower portion (e.g., complete ring structure). In some embodiments, two partial ring structures (e.g., arc segments) and two gaps extend upward from a lower portion (e.g., complete ring structure). In some embodiments, three partial ring structures (e.g., arc segments) and three gaps extend upward from a lower portion (e.g., complete ring structure). In some embodiments, four partial ring structures (e.g., arc segments) and four gaps extend upward from a lower portion (e.g., complete ring structure). In some embodiments, a guard element comprises any suitable number of partial ring structures and gaps.

In some embodiments, a guard element is capable of rotating with respect to an actuatable element and/or the device or apparatus to which it is attached. In some embodiments, a guard element is static with respect to an actuatable element and/or the device or apparatus to which it is attached. In some embodiments, a guard element is prevented from rotating with respect to an actuatable element and/or the device or apparatus to which it is attached (e.g., by an anti-rotation pin). In some embodiments, an anti-rotation pin interacts with the lower portion of the guard element to prevent rotation.

In some embodiments, a guard element comprises a lower portion and an upper portion. In some embodiments, the lower portion comprises a complete ring structure. In some embodiments, a lower ring structure is configured to completely surround the periphery of an actuatable element. In some embodiments, a lower ring structure is configured to completely surround the periphery of the base of an actuatable element. In some embodiments, a lower ring structure is configured to completely surround the periphery of the bottom of an actuatable element. In some embodiments, the upper portion comprises two partial ring structures and two gaps. In some embodiments, upper partial ring structures are configured to partially surround the periphery of an actuatable element. In some embodiments, an upper partial ring structure extends from the top of the lower ring structure to a height equivalent to the top of an actuatable element in its fully raised position. In some embodiments, an upper partial ring structure extends from the top of the lower ring structure to a height just below top of an actuatable element in its fully raised position (e.g., 1 mm below . . . 2 mm below . . . 3 mm below . . . 4 mm below . . . 5 mm below . . . 6 mm below . . . 7 mm below . . . 8 mm below . . . 9 mm below, etc.). In some embodiments, an upper partial ring structure extends from the top of the lower ring structure to a height about 3.5 mm below top of an actuatable element in its fully raised position. In some embodiments, each upper partial ring structure covers about 25% of the periphery (i.e., 90°) of an actuatable element. In some embodiments, each upper gap reveals about 25% of the periphery (i.e., 90°) of an actuatable element.

In some embodiments, a guard element and actuatable element comprise any materials suitable for their construction (e.g., plastics, metals, glass, wood, rubber, etc.). The elements described herein are not limited by the combinations of materials used to construct them.

In some embodiments, the guard elements and actuatable elements described herein are provided as part of a system also comprising a device, apparatus, machine, etc. (e.g., security screening device, manufacturing equipment, etc.) to which the guard element and actuatable element are attached or a part of. In some embodiments, an actuatable element is associated with, or a part of, a device, apparatus, machine, etc. (e.g., security screening device, manufacturing equipment, etc.). In some embodiments, an actuatable element is an E-stop button associated with, attached to, or a part of a device, apparatus, machine, etc. (e.g., security screening device, manufacturing equipment, etc.). In some embodiments, a system comprises a guard element surrounding an actuatable element (e.g., E-stop button) associated with a security screening device, x-ray bag inspection device, security inspection systems, metal detector (e.g., for bags or people), body scan system, mmWave security scanners, etc. In some embodiments, a system comprises a guard element surrounding an actuatable element (e.g., E-stop button) associated with manufacturing equipment, a factory production line, construction equipment, a vehicle, etc. In some embodiments, an actuatable element (e.g., E-stop button) is part of a device, apparatus, machine, etc. In some embodiments, an actuatable element (e.g., E-stop button) is attached to a device, apparatus, machine, etc. In some embodiments, an actuatable element and guard element are attached to a keyboard, control board, housing, etc. of a device, apparatus, and/or machine.

We claim:

1. A system comprising: an actuatable element configured to adopt a raised position and a depressed position, and a guard element surrounding the actuatable element, wherein the guard element has a top edge and the actuatable element has a top surface, wherein the top surface of the actuatable element is higher than the top edge of the guard element when the actuatable element is in the raised position, wherein the top edge of the guard element is higher than the top surface of the actuatable element when the actuatable element is in the depressed position, and wherein the guard element encloses all or a portion of the periphery of the actuatable element but does not obstruct the top surface of the actuatable element.

2. The system of claim 1, wherein the guard element comprises a lower portion that completely encloses the periphery of the actuatable element, and an upper portion that partially encloses the periphery of the actuatable element.

3. The system of claim 2, wherein the lower portion of the guard element comprises a ring structure, and wherein the ring structure encircles the bottom of the actuatable element.

4. The system of claim 3, wherein the upper portion comprises one or more arc segments and one or more gaps, wherein the arc segments of the upper portion partially encircle the actuatable element.

5. The system of claim 4, wherein the upper portion comprises two arc segments and two gaps.

6. The system of claim 5, wherein each the two arc segments are of equal length and the two gaps are of equal length.

7. The system of claim 6, wherein each arc segment has a central angle of 70-110°.

8. The system of claim 7, wherein each arc segment has a central angle of about 90°.

9. The system of claim 1, wherein the top surface of the actuatable element is 1-5 mm higher than the top edge of the guard element when the actuatable element is in the raised position.

10. The system of claim 9, wherein the top surface of the actuatable element is about 3.5 mm higher than the top edge of the guard element when the actuatable element is in the raised position.

11. The system of claim 1, wherein the actuatable element comprises a button.

12. The system of claim 11, wherein the button comprises a top surface, stalk, and base element.

13. The system of claim 12, wherein the base element is attached to a device or apparatus.

14. The system of claim 13, wherein the button is an emergency stop button for the device or apparatus.

15. The system of claim 12, wherein the stalk is configured to retract into and extend from the base element.

16. The system of claim 15, wherein application of a force from above the top surface results in the stalk retracting into the base element and the actuatable element moving from the raised position to the depressed position.

17. The system of claim 16, wherein the guard element limits access for the application of force to the actuatable element.

18. A method of preventing unintentional actuation of an actuatable element, while allowing intentional actuation of the actuatable element comprising providing a guard element around the actuatable element, wherein the actuatable element has a raised and a lowered position, wherein the guard element limits access to the actuatable element for the periphery of the actuatable element, wherein the guard element has a top opening that allows access from above the actuatable element to objects smaller that the top opening of the guard element , wherein the guard element prevents a rigid object with a cross-section larger than the top opening of the guard element from actuation the actuatable element from the raised position to the depressed position, and wherein the guard element allows a sufficiently flexible or malleable object with a cross-section larger than the top opening of the guard element to actuate the actuatable element from the raised position to the depressed position.

19. The method of claim 18, wherein the actuatable element is a button.

20. The method of claim 18, wherein the sufficiently flexible or malleable object is the hand, palm, of fingers of a user.
